(19) United States
(12) Patent Application Publication
(10) Pub. No.: US 2010/0177099 A1
(43) Pub. Date: Jul. 15, 2010

(54) METHOD AND SYSTEM OF INTERACTION OF A COMPUTER SYSTEM WITH A USER

(75) Inventor: Gilbert Benoit, Perols (FR)

Correspondence Address: YOUNG & THOMPSON, 209 Madison Street, Suite 500, Alexandria, VA, 22314, US

(73) Assignee: NEGOFI, Paris (FR)

(21) Appl. No.: 12/095,518

(22) PCT Filed: Nov. 29, 2006
(86) PCT No.: PCT/FR06/02617

§ 371 Date: May 30, 2008

(30) Foreign Application Priority Data
Nov. 30, 2005 (FR) 0512120

(51) Int. Cl. G06T 11/20; G06F 3/048

(52) U.S. Cl. 345/440; 715/810

(57) ABSTRACT

Method of interaction of a computer system with a user, including: a representation, in a display area (11), of a plurality of items of information each comprising a plurality of values, the representation being graphical representation (1111, 1121) in at least two dimensions along coordinate axes (161, 162); a display, in the display area (11), of a mobile marker (21) allowing the user to choose a position with the help of a pointing device: an evaluation, by calculating the distance of the chosen position with respect to the axes (161, 162) of the coordinates of the chosen position; calculation, on the basis of the coordinates, of a pair of values, and; triggering, on the basis of the pair of calculated values, of a specified processing.

The present invention relates to a method and a system of interaction of an information system with a user. The field of the invention is the field of information technology and more precisely the field of interfaces enabling a user to interact with an information system, concerning the data displayed by this system.

The invention applies more particularly to graphic interfaces for displaying data with real-time updates.

Methods and systems of interaction of an information system with a user already exist. U.S. Pat. No. 6,938,011 thus discloses a method of interaction of an information system with a user. The data are displayed in the form of a table the boxes of which are completed with values representing these data.

Such a method of interaction presents a limited ergonomy. As a matter of fact, does such a method enable the user to quickly read the displayed data. The user cannot therefore interact rapidly.

Another disadvantage of such a method is that it does not enable the user to view operations carried out in the recent past which could have an effect on the interaction of the user with the information system concerned.

Finally, such a method does not enable certain practical operations concerning the displayed data, such as operations of summing and averaging certain values making up these data.

An aim of the invention is to overcome the aforementioned disadvantages of the prior art.

The aim of the invention is also to propose a method enabling a more rapid interaction of an information system with a user by offering the user a more practical way of viewing data displayed by the information system.

Another aim of the invention is to propose a method of interaction enabling a review of the operations carried out in the recent past that might influence the interaction of the user with the information system.

Finally, an aim of the invention is to propose certain practical functions which could assist the user in the interpretation of the data.

The invention proposes to achieve these aims and to deal with the aforementioned problems by a method of interaction of an information system with a user, comprising:
a representation, in a display zone, of a plurality of items of information each comprising a plurality of values, the representation being a graphic representation in at least two dimensions along axes of coordinates,
a display, in the display zone, of a mobile marker enabling the user to choose a position using a pointing device,
an evaluation, by calculating the distance from the chosen position in relation to the axes, of the coordinates of the chosen position,
calculation, from the coordinates, of a pair of values, and
triggering, from the calculated pair of values, of a determined processing operation.

Advantageously the invention enables a graphic representation of the displayed data, which makes easier and accelerates the interpretation of the data by the user. The data can then be interpreted visually. A quicker interpretation of the results enables a more effective interaction of the user with the information system, which is essential in all fields requiring a substantial reactivity on the part of the user. For example, in the stock market field it is very important to interpret the received data all the time and to react accordingly.

The method according to the invention enables the user to be assisted in the interaction with the information system by a triggering of a processing operation from the position of a marker. Such a

triggering enables time to be saved which is very advantageous and useful when the user is required to react quickly.

Advantageously, the display zone comprises at least two display areas, each comprising a representation of a predetermined particular category of the data, these two display areas comprising at least one common datum, termed reference datum. This enables a plurality of categories of data to be separated and a representation of each of the categories of data to be carried out in a determined display area in order to enable displayed data to be viewed more easily. The displayed data are thus more organized and the user does not waste time searching for data. Moreover, this enables data from the same category to be grouped in a single display area.

The display areas can then display a so-called reference datum enabling a rapid connection or comparison to be made between the different data displayed in the different display areas of the display zone.

In an advantageous version of the method according to the invention, at least two areas of the display zone may be adjacent such that the common reference datum is represented once only in total over these areas. This enables a continuity of representations over a plurality of display areas and therefore facilitates the interpretation of the data. This also enables the possibility of having several areas which are adjacent and therefore easy to view.

Advantageously, such an organization of a plurality of display areas also enables the use of an axis system common to a plurality of areas for a representation of the data in a plurality of areas.

In an advantageous version, the graphic representation of at least one datum may comprise a geometric form, some at least of the dimensions of which are calculated from at least one of the values corresponding to said datum.

Moreover, the graphic representation of at least one datum comprises a geometric form in a position in which at least one of the

coordinates is calculated from at least one of the corresponding values.

In fact, the geometric representations of the data may be positioned and dimensioned according to a plurality of values each corresponding either to a coordinate of the position of the representation relative to an axis, or to a dimension of the graphic representation along an axis.

A graphic representation may be a dot, a bar, a curve, a collection of dots or any other graphic representation, in two or three dimensions.

In the case of a graphic representation of a datum in the form of a two-dimensional bar, the thickness of the bar may be constant. A value corresponding to the datum represented by this bar may be used for calculating a coordinate of the position of this bar in relation to an axis. This value may be a price and the axis a price axis.

The size of the bar may then be calculated using another datum representing a coordinate in relation to another axis. This other value may be a quantity and the axis in question a quantity axis.

In the same way, the representation of a datum in the form of a bar may be achieved firstly by calculating a position using a plurality of corresponding values, for example price and quantity, the coordinates of a position in relation to two axes, |and connecting|_{[FA1]} this point to one of the two axes in parallel to the other axis.

In particular, the method according to the invention may comprise, for the graphic representation of at least one datum, an indication of at least one corresponding value close to said graphic representation. This value may be displayed in a position the coordinates of which are close to at least one coordinate of the position of graphic representation in question.

In an advantageous version the method according to the invention may comprise a calculation of the sum of at least some of the values corresponding to the data, the position of the graphic representations of which has coordinates comprised between, on the one hand, the coordinates of the position of the marker and, on the other hand, the coordinates

of the position of the graphic representation of a reference datum.

Similarly, the method may comprise a calculation of the weighted average of at least some of the values corresponding to the data, the position of the graphic representations of which has coordinates comprised between, on the one hand, the coordinates of the position of the marker and, on the other hand, the coordinates of the position of the graphic representation of a reference datum.

In an advantageous version of the method according to the invention, a calculation of at least one coordinate of a position of a graphic representation may comprise a calculation of the distance of said position in relation to at least one axis.

Moreover, the calculated sum or average may be displayed in a predetermined display zone.

The triggering of a processing operation may in particular be carried out by a selection of a determined processing operation using selection tools, from a menu containing a plurality of processing operations.

The method according to the invention may comprise the display of a menu containing a plurality of processing operations, or of a zone containing a plurality of selection buttons enabling the user to select a processing operation according to the position of the marker.

The selection may be made using the keys of a keyboard, for example keys F1-F12, or a mouseclick on a button corresponding to a processing operation. The processing operations that can be selected may for example be purchase orders, sales, concerning a market quotation, the values of which are graphically represented in the display zone and the representation of which is indicated by the marker.

Moreover, the method according to the invention enables recovery of at least some of the values corresponding to the graphic representation indicated by the marker, and the routing of these values to another application.

Advantageously the method according to the invention may comprise an indication, using an indication zone, of at least one coordinate of the position of the marker in relation to at least one axis.

Moreover, in an advantageous feature of the method according to the invention the indication zone may receive data relating to positioning of the marker from the user by means of a positioning-entry tool. The positioning-entry tool may, for example, be a tool of keyboard type.

Thus, the user may enter at least one coordinate of a position in which he wishes to place the marker, and he is informed in real time of the position of the marker.

In an advantageous version, the method according to the invention may comprise a plurality of display scales enabling at least one of the following parameters to be varied: a dimension of a representation, a number of represented data, a number of displayed values for a represented datum. The selection of a display scale may be achieved by a combination of keys of a keyboard, or by a mouse wheel etc. Selecting a scale may mean a modification of the number of represented data and therefore of the number of graphic representations in the display zone. Thus, the method according to the invention enables, according to the viewing scale chosen by the user, an automatic addition or deletion, in the display zone, of a graphic representation corresponding to a datum. Using this feature, the user may adjust the number of data to be viewed.

In an advantageous version of the method according to the invention, a modification of at least one value from the plurality of values corresponding to a datum may mean an adjustment of the graphic representation of said datum. This adjustment may comprise a modification of the dimensions of the graphic representation of the datum concerned, at least one of the coordinates of the representation. The adjustment may also comprise a deletion of a graphic representation of a datum or an addition of a new representation corresponding to a new datum.

The method according to the invention may advantageously comprise a graphic representation of a datum relating to a past processing operation. This representation can be similar to a representation of a

real-time datum with an element enabling the former to be differentiated. It may for example be in the same form but in a different colour or in the same colour and a different form or finally in a different form and colour.

It can also be envisaged that a graphic representation corresponding either to a processing of a past datum or to a datum processed in the past is represented in an area of the display zone so as to be related, or correlated, to at least one other datum through its graphic representation. This relationship may be created by using geometric properties, for example symmetries, between the different graphic representations.

Advantageously, at least some of the data represented can be real-time data. These data may be very changeable or fluctuating data such as, for example, items of stock-market data or traffic data.

The method according to the invention can advantageously be used to realize the interaction of an information system enabling stock-market data to be displayed. Stock-market data are very often real-time data which require a rapid interpretation and response. It is therefore necessary for the interaction between the information system displaying the stock-market data and the user to be carried out as quickly as possible.

According to another feature of the invention, a system of interaction of an information system with a user is proposed, implementing the method and comprising:
means for displaying, in a display zone, a plurality of items of information each comprising a plurality of values, the representation being a graphic representation in at least two dimensions according to the axes (161, 162) of coordinates,
means for displaying, in the display zone, a mobile marker enabling the user to choose a position using a pointing device,
means for evaluating, by calculating the distance of the chosen position in relation to the axes, coordinates of the chosen position,
means for calculating, from these coordinates, a pair of values, and
means for triggering, from this calculated pair of values, a determined processing operation.

Other advantages and features will appear upon examination of the detailed description of an embodiment that is no way limitative and of the attached drawings in which

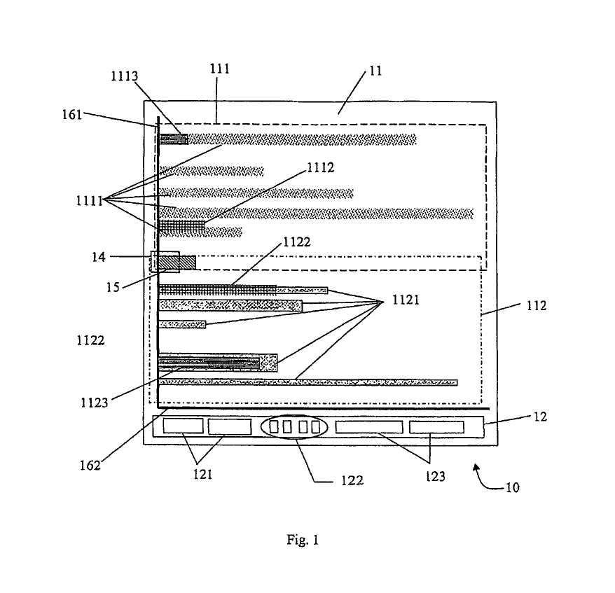

FIG. 1 is a diagram of a graphic interface enabling an interaction to be carried out with an information system by means of the method according to the invention,

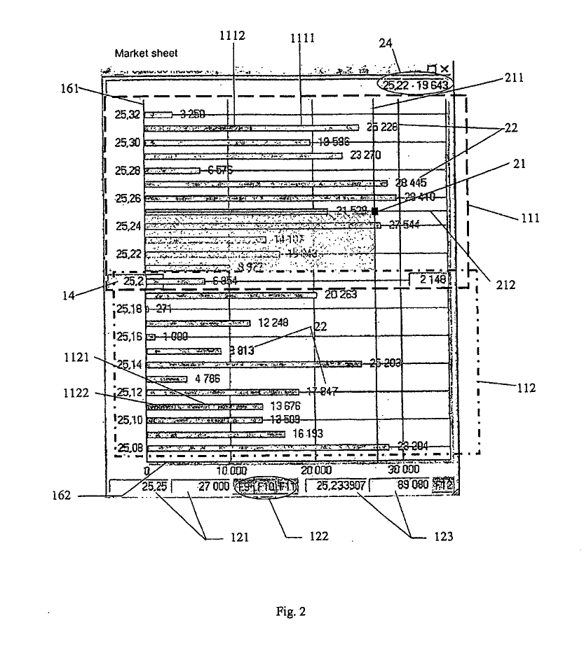

FIG. 2 is an example of a graphic interface enabling an interaction to be carried out with an information system according to the invention, by the method according to the invention, and

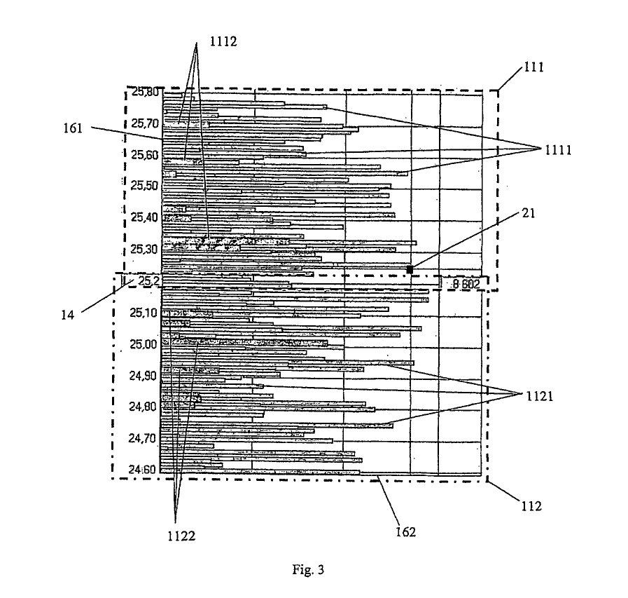

FIG. 3 is a zoom example by a graphic interface enabling an interaction to be carried out with an information system.

In the present example, the information system with which the user is interacting enables stock-market data to be processed. The interaction with the user is carried out using a window, a schematic example of which is presented in FIG. 1. This window will be called “market sheet” in the description below. FIG. 2 shows an example of a market sheet according to the invention.

The market sheet 10 comprises a display zone 11 composed of two display areas 111 and 112. It also comprises a system of axes comprising two axes 161 and 162, and a menu zone 12. In each display zone 111 and 112, there are graphic representations

1111, 1121 which are in fact a collection of dots, represented here in the form of grey bars or dots in the form of crosses (dots).

The form of the graphic representation enables the category of data represented to be differentiated. The categories of data represented may also be differentiated by using the same geometric form, but in different colours.

In FIG. 1, two different categories of data are represented in two different display areas 111 and 112. The geometric forms represent, for a given product, the proposed sales in area 111 and the proposed purchases propositions in area 112.

As represented in FIG. 1, for a given product, the market sheet may be regarded as a double series of dots:
a series of dots representing the proposed sales for this product, in display area 111 and
a series of dots representing the proposed purchases, in area 112.

Each series of dots represents, inter alia, a price datum in relation to a price axis 161, and a quantity datum in relation to a quantity axis 162.

The two areas 111 and 112 have as a common element a graphic representation 15 in the form of a bar showing the quotation price in relation to the axes 161 and 162. The quotation price can be regarded as a reference element for areas 111 and 112.

As these are proposed transactions awaiting execution in the market, the proposed sale prices are higher than the quotation price, area 111, and the proposed purchase prices are lower than the quotation price, area 112.

For each display area 111 and 112, the market sheet also enables data to be displayed in relation to time. For each area 111 and 112, FIG. 1 shows graphic representations 1112, 1122 of stock-market data processing operations carried out in the past. More precisely, these representations 1112 and 1122 represent at least one last transaction carried out for a given price.

For each display area 111 and 112 of the market sheet 10, the market sheet therefore comprises:
a first series of dots representing the current transactions in the form of bars or dots 1111 and 1121,
a second series of dots in the form of bars representing the market price 15 and the last transaction carried out 14 (at the market price), and
a third series of dots representing the last transactions carried out in the market by a series of dots in the form of bars 1112 and 1122. This last series of dots enables the recent past of the market to be characterized.

All these series may also be displayed by other graphic representations such as curves, broken lines, clusters of dots, stairstep lines, etc.

If the surface area of the display zone enables, the coordinates 22 of the positions of the graphic representations in relation to the axes 161 and 162 may also be displayed close to these representations. In the particular case of the bars it is the coordinates of the ends of the bars which will be given. In all cases, the coordinates of a dot will be composed of a price value and a quantity value.

The market sheet also enables an order book of the user to be displayed. Thus, thanks to the graphic representations 1113 and 1123, the market sheet enables the sale or purchase orders placed by the user himself to be represented. In a particular version of the invention, these orders may be accrued with the orders of other users. Therefore, for each area, a fourth series of dots, enabling the orders placed by the user himself to be displayed, is added to the three series of dots mentioned above.

Moreover, as FIG. 2 shows, the market sheet comprises at least one marker/reticule 21 composed of two lines 211 and 212 parallel to each of the axes. The coordinates of the position of this marker are displayed in the boxes 121. These coordinates correspond to a price and a quantity in relation to axes 161 and 162. This reticule can be positioned by the user, using a pointing element

such as a mouse or by using a keyboard. It enables the user to be informed of his position. The user can also place the reticule in a particular position by entering the coordinates of the position in the box 121.

Advantageously, the market sheet enables the user to be informed, using a display zone 123, of the cumulative total of all the proposed purchases or sales situated between the current position of the reticule 21 and the market price 14, as well as the average weighted price. This enables the proposed sale volume below a given price, or the proposed purchase volume above a given price, as well as the average weighted price of this quantity, to be discovered very quickly.

Close to the zones 121 on which the coordinates of the reticule, price and quantity are displayed, the user has a plurality of buttons 122 enabling him to initiate a purchase, sell or match (simultaneous purchase and sale of the same quantity) order. The prices displayed in the zones 121 are automatically listed on an order-placement form. These order-placement functions may also be activated using keys or combinations of keys, F9, F10 F11 for example.

Close to the zones 123 the user has at least one button which enables him to initiate a purchase or sale order. The quantity displayed in this zone is listed on a purchase or sale form. The proposed direction (purchase or sale) is determined by the position of the reticule on the graphic. If the reticule is in zone 111 of the proposed sales, the proposed direction will be purchase and vice versa.

Finally, using a pointing device, for example a mouse wheel, keys of a keyboard or of buttons located on the market sheet, the user can zoom in, varying the number of dots displayed on the market sheet and the number of dots in the series of recent transactions. When the number of dots becomes too large, the coordinates of each dot are no longer displayed. The user can however assess these values pretty accurately by placing a pointing element, a mouse for example, on a dot. The position of this dot will be displayed in a display zone 24.

The invention is not limited to the example just described above and can be applied to the interaction of a user with an information system enabling all sorts of real-time data, such as traffic, meteorological data etc., to be displayed.

1. Method of interaction of an information system with a user, comprising:
a display, in a display zone (11),
on the one hand of a graphic representation of at least two predetermined data categories respectively in at least two display areas, each of said data comprising a plurality of values, said representation being a graphic representation (1111, 1121) in at least two dimensions along axes (161, 162) of coordinates, and
on the other of a mobile marker (21) enabling the user to choose a position using a pointing device;
an evaluation, by calculating the distance from the chosen position in relation to said axes (161, 162), of the coordinates of said chosen position,
calculation, from said coordinates, of a pair of values, and
triggering, from said calculated pair of values, of a determined processing operation,
said display also comprising a graphic representation, in each of said areas, of a common, so-called reference, datum (14, 15) forming part of each of said data categories.

2. Method according to claim 1, characterized in that at least two areas (111, 112) of the display zone (11) are adjacent such that the common reference datum (14, 15) is represented once only in total over said areas (111, 112).

3. Method according to claim 1, characterized in that the display comprises a graphic representation along two orthogonal axes, respectively, of a quantity datum of and of a price datum.

4. Method according to claim 1, characterized in that the graphic representation (1111, 1121) of at least one datum comprises a geometric form some at least of the dimensions of which are calculated from at least one of the values corresponding to said datum.

5. Method according to claim 1, characterized in that the graphic representation (1111, 1121) of at least one datum comprises a geometric form in a position at least one of the coordinates of which is calculated from at least of one of the corresponding values.

6. Method according to claim 1, characterized in that it also comprises, for the graphic representation of at least one datum, an indication (22) of at least one corresponding value close to said graphic representation (1111, 1121).

7. Method according to claim 1, characterized in that it also comprises a calculation of the sum of at least some of the values corresponding to the data, the position of the graphic representations (1111, 1121) of which has coordinates comprised between, on the one hand, the coordinates of the position of the marker (21) and, on the other, the coordinates of the position of the graphic representation of a reference datum (14, 15).

8. Method according to claim 1, characterized in that it also comprises a calculation of the weighted average of at least some of the values corresponding to the data, the position of the graphic representations (1111, 1121) of which has coordinates comprised between, on the one hand the coordinates of the position of the marker (21) and, on the other hand, the coordinates of the position of the graphic representation of a reference datum (14, 15).

9. Method according to claim 1, characterized in that the calculation of at least one coordinate of a position of a graphic representation comprises a calculation of the distance of said position in relation to at least one axis (161, 162).

10. Method according to claim 1, characterized in that the triggering of a processing operation is carried out in response to a selection of a processing operation determined by using the selection tool, from a menu (122) containing a plurality of processing operations (F9, F10, F11, F12).

11. Method according to claim 1, characterized in that it also comprises an indication, using an indication zone (121) of at least one coordinate of the position of the marker (21) in relation to at least one axis (161, 162).

12. Method according to claim 10, characterized in that the indication zone (121) receives data relating to positioning of the marker (21) from the user by means of a positioning-entry tool.

13. Method according to claim 1, characterized in that it also comprises a plurality of display scales enabling at least one of the following parameters to be varied: a dimension of a representation, a number of represented data, a number of displayed values for a represented datum.

14. Method according to claim 1, characterized in that a modification of at least one value from the plurality of values corresponding to a datum means an adjustment of the graphic representation (1111, 1121) of said datum.

15. Method according to claim 1, characterized in that it also comprises a graphic representation (1112, 1122) of a datum relating to a past processing operation.

16. Method according to claim 1, characterized in that at least some of the represented data are real-time data.

17. System of interaction of an information system with a user, implementing the method according to claim 1, comprising:
means for displaying, in a display zone (11),
on the one hand a representation of at least two predetermined data categories respectively in at least two display areas, each of said data comprising a plurality of values, said representation being a graphic representation (1111, 1121) in at least two dimensions along axes (161, 162) of coordinates, and
on the other a mobile marker (21) enabling the user to choose a position using a pointing device;
means for evaluating, by calculating the distance of the chosen position in relation to said axes (161, 162), coordinates of said chosen position,
means for calculating, from these coordinates, a pair of values, and
means for triggering, from this calculated pair of values, a determined processing operation.
said means for displaying also comprising means for displaying a graphic representation, in each of said areas, of a common datum (14, 15), termed reference datum, forming part of each of said data categories.
